(19) United States
(12) Patent Application Publication
(10) Pub. No.: US 2025/0038802 A1
(43) Pub. Date: Jan. 30, 2025

(54) MULTI-RADIO ACCESS TECHNOLOGY ANTENNA MANAGEMENT

(71) Applicant: QUALCOMM Incorporated, San Diego, CA (US)

(72) Inventors: Thawatt GOPAL, San Diego, CA (US); Shriram GURUMOORTHY, Denver, CO (US); Kamalakar GANTI, San Marcos, CA (US)

(21) Appl. No.: 18/736,235

(22) Filed: Jun. 6, 2024

Related U.S. Application Data
(60) Provisional application No. 63/516,426, filed on Jul. 28, 2023.

(51) Int. Cl. H04B 7/06; H04B 1/00; H04B 7/08

(52) U.S. Cl. CPC H04B 7/0608; H04B 1/0064; H04B 7/0834

(57) ABSTRACT

Methods, systems, and devices for wireless communication are described. The method may include a user equipment (UE) tuning a first antenna panel to a first frequency band associated with a first radio access technology (RAT) and tuning a second antenna panel to a second frequency band associated with a second RAT. Further, the method may include monitoring a traffic level of communications via the first frequency band associated with the first RAT and selecting a third antenna panel for communications via the second frequency band based on the traffic level and an isolation level between the first antenna panel and the second antenna panel.

### CROSS REFERENCE

The present application for patent claims the benefit of U.S. Provisional Patent Application No. 63/516,426 by GOPAL et al., entitled “MULTI-RADIO ACCESS TECHNOLOGY ANTENNA MANAGEMENT,” filed Jul. 28, 2023, assigned to the assignee hereof, and expressly incorporated by reference herein.

### FIELD OF TECHNOLOGY

The following relates to wireless communication, including multi-radio access technology (RAT) antenna management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, the UE may support multiple radio access technologies (RATs) and may utilize different antenna panels to communicate using the multiple RATs. For example, the UE may tune one or more first antenna panels to a frequency range associated with a first RAT and one or more second antenna panels to a frequency range associated with a second RAT.

### SUMMARY

The described techniques relate to improved methods, systems, devices, and apparatuses that support multi-radio access technology (RAT) antenna management. In some examples, a user equipment (UE) may tune a first antenna panel to a first frequency band associated with a first RAT and a second antenna panel to a second frequency band associated with a second RAT. The UE may monitor a traffic level of communications via the first frequency band and select a third antenna for communications via the second frequency band based on the traffic level and an isolation level between the first antenna panel and the second antenna panel.

A method for wireless communications by a UE is described. The method may include tuning a first antenna panel to a first frequency band associated with a first RAT, tuning a second antenna panel to a second frequency band associated with a second RAT, monitoring a traffic level of communications via the first frequency band associated with the first RAT, and selecting a third antenna panel for communications via the second frequency band based on the traffic level and an isolation level between the first antenna panel and the second antenna panel.

A UE for wireless communications is described. The UE may include one or more memories storing processor executable code, and one or more processors coupled with the one or more memories. The one or more processors may individually or collectively operable to execute the code to cause the UE to tune a first antenna panel to a first frequency band associated with a first RAT, tune a second antenna panel to a second frequency band associated with a second RAT, monitor a traffic level of communications via the first frequency band associated with the first RAT, and select a third antenna panel for communications via the second frequency band based on the traffic level and an isolation level between the first antenna panel and the second antenna panel.

Another UE for wireless communications is described. The UE may include means for tuning a first antenna panel to a first frequency band associated with a first RAT, means for tuning a second antenna panel to a second frequency band associated with a second RAT, means for monitoring a traffic level of communications via the first frequency band associated with the first RAT, and means for selecting a third antenna panel for communications via the second frequency band based on the traffic level and an isolation level between the first antenna panel and the second antenna panel.

A non-transitory computer-readable medium storing code for wireless communications is described. The code may include instructions executable by a processor to tune a first antenna panel to a first frequency band associated with a first RAT, tune a second antenna panel to a second frequency band associated with a second RAT, monitor a traffic level of communications via the first frequency band associated with the first RAT, and select a third antenna panel for communications via the second frequency band based on the traffic level and an isolation level between the first antenna panel and the second antenna panel.

In some examples of the method, UEs, and non-transitory computer-readable medium described herein, monitoring the traffic level may include operations, features, means, or instructions for monitoring the traffic level of communications via the first frequency band based on the first frequency band overlapping with, being adjacent to, being a harmonic order to, or being an intermodulation order to the second frequency band.

In some examples of the method, UEs, and non-transitory computer-readable medium described herein, selecting the third antenna panel may include operations, features, means, or instructions for selecting the third antenna panel for communications via the second frequency band based on the traffic level satisfying a threshold traffic level.

In some examples of the method, UEs, and non-transitory computer-readable medium described herein, selecting the third antenna panel may include operations, features, means, or instructions for selecting the third antenna panel different from the second antenna panel based on the traffic level exceeding a threshold traffic level.

Some examples of the method, UEs, and non-transitory computer-readable medium described herein may further include operations, features, means, or instructions for performing isolation level measurements for antenna panels of different pairs of antenna panels, where each pair of antenna panels includes an antenna panel associated with the first RAT and an antenna panel associated with the second RAT.

Some examples of the method, UEs, and non-transitory computer-readable medium described herein may further include operations, features, means, or instructions for generating a first list of antenna panels, a second list of antenna panels, or both, where the first list includes antenna panels associated with the second RAT and that correspond to antenna panel pairs that exceed a threshold isolation level, and where the second list includes antenna panels associated with the second RAT and that correspond to antenna panel pairs that may be below the threshold isolation level.

In some examples of the method, UEs, and non-transitory computer-readable medium described herein, selecting the third antenna panel may include operations, features, means, or instructions for selecting the third antenna panel from the first list and selecting the third antenna panel that may be exclusive of the second list.

In some examples of the method, UEs, and non-transitory computer-readable medium described herein, selecting the third antenna panel may include operations, features, means, or instructions for selecting any antenna panel from a set of antenna panels associated with the second RAT based on the traffic level being below a threshold traffic level.

In some examples of the method, UEs, and non-transitory computer-readable medium described herein, selecting the third antenna panel may include operations, features, means, or instructions for selecting the third antenna panel based on whether a form factor state of the UE includes a first form factor state or a second form factor state, the first form factor state including an open state and the second form factor state including a closed state.

In some examples of the method, UEs, and non-transitory computer-readable medium described herein, monitoring the traffic level may include operations, features, means, or instructions for monitoring a quantity of packets communicated via the first frequency band associated with the first RAT within a time window.

In some examples of the method, UEs, and non-transitory computer-readable medium described herein, the first RAT may be associated with a higher priority than the second RAT.

In some examples of the method, UEs, and non-transitory computer-readable medium described herein, the first RAT includes one of wireless local area network (WLAN), Bluetooth (BT), Bluetooth Low Energy (BLE), Ultra-wideband (UWB), and the second RAT includes wireless wide area network (WWAN).

### BRIEF DESCRIPTION OF THE DRAWINGS

FIG. 1 shows an example of a wireless communications system that supports multi-radio access technology (RAT) antenna management in accordance with one or more aspects of the present disclosure.

FIG. 2 shows an example of a wireless communications system that supports multi-RAT antenna management in accordance with one or more aspects of the present disclosure.

FIG. 3A shows an example of a flow diagram that supports multi-RAT antenna management in accordance with one or more aspects of the present disclosure.

FIG. 3B shows an example of a system that supports multi-RAT antenna management in accordance with one or more aspects of the present disclosure.

FIG. 4A shows an example of a flow diagram that supports multi-RAT antenna management in accordance with one or more aspects of the present disclosure.

FIGS. 4B and 4C show examples of a system that supports multi-RAT antenna management in accordance with one or more aspects of the present disclosure.

FIG. 5 shows an example of a process flow that supports multi-RAT antenna management in accordance with one or more aspects of the present disclosure.

FIGS. 6 and 7 show block diagrams of devices that support multi-RAT antenna management in accordance with one or more aspects of the present disclosure.

FIG. 8 shows a block diagram of a communications manager that supports multi-RAT antenna management in accordance with one or more aspects of the present disclosure.

FIG. 9 shows a diagram of a system including a device that supports multi-RAT antenna management in accordance with one or more aspects of the present disclosure.

FIGS. 10 and 11 show flowcharts illustrating methods that support multi-RAT antenna management in accordance with one or more aspects of the present disclosure.

### DETAILED DESCRIPTION

In some examples, a user equipment (UE) may operate according to different radio access technologies (RATs) and may include (or utilize) different sets of antenna panels for communicating according to the RATs. For example, a UE may include a first set of antenna panels dedicated to a first RAT and a second set of antenna panels dedicated to a second RAT. The UE may enable the first RAT and tune an antenna panel included in the first set of antenna panels to a first frequency band associated with the first RAT. Additionally, the UE may enable the second RAT and tune an antenna panel included in the second set of antennas to a second frequency associated with the second RAT. However, in some examples, the first frequency band may be adjacent to or overlap the second frequency band, which may result in interference if the antennas do not have sufficient isolation (e.g., isolation level between the antennas is below a threshold).

As described herein, the UE may implement a RAT co-existence mitigation policy if a likelihood of interference between antenna panels is above a threshold. In one example, the UE may identify that antenna panels of different RATs (e.g., the first RAT and the second RAT) are tuned to problematic frequency bands. Problematic frequency bands may include frequency bands that are adjacent to one another or overlap, or may cause interference with one another. Further, the UE may determine a prioritization of the RATs. As one example, the first RAT may be associated with a higher priority than the second RAT. In some cases, the UE may determine a list of blacklisted antenna panels associated with either the first RAT or the second RAT. Blacklisted antenna panels may be antenna panels of different RATs that are not isolated from one another.

If problematic frequency bands are discovered, the UE may monitor a transmission and a reception activity of the higher priority RAT (or the first RAT) and compare the activity to a threshold. If the activity is higher than the threshold, the UE may select an antenna that is not included in the blacklisted antenna panels to use for communications via the second frequency band associated with the second RAT. The techniques described herein may reduce interference between antenna panels of different RATs.

Aspects of the disclosure are initially described in the context of wireless communications systems. Additional aspects are described in the context of flow diagrams, systems, and a process flow. Aspects of the disclosure are further illustrated by and described with reference to apparatus diagrams, system diagrams, and flowcharts that relate to multi-RAT antenna management.

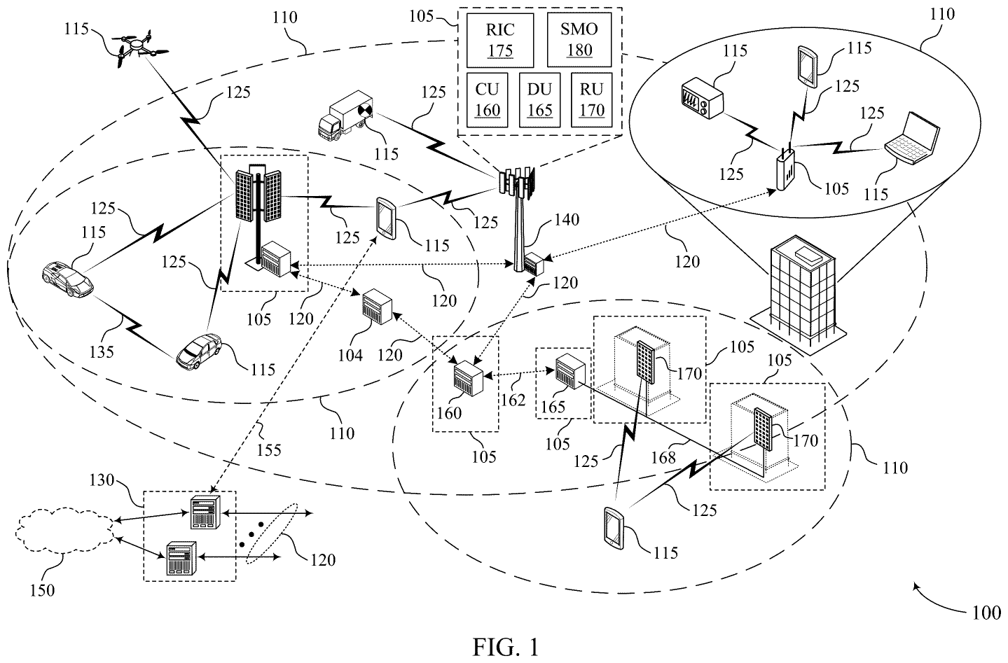

FIG. 1 shows an example of a wireless communications system 100 that supports multi-RAT antenna management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support multi-RAT antenna management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, the UE 115 may implement a co-existence mitigation procedure to mitigate interference between antennas of a UE 115, such as those supporting different RATs. The co-existence mitigation procedure may include the UE 115 tuning a first antenna panel to a first frequency band associated with a first RAT and a second antenna panel to a second frequency band associated with a second RAT. Further, the co-existence mitigation procedure may include the UE 115 monitoring a traffic level of communications via the first frequency band and selecting a third antenna for communications via the second frequency band based on the traffic level and an isolation level between the first antenna panel and the second antenna panel.

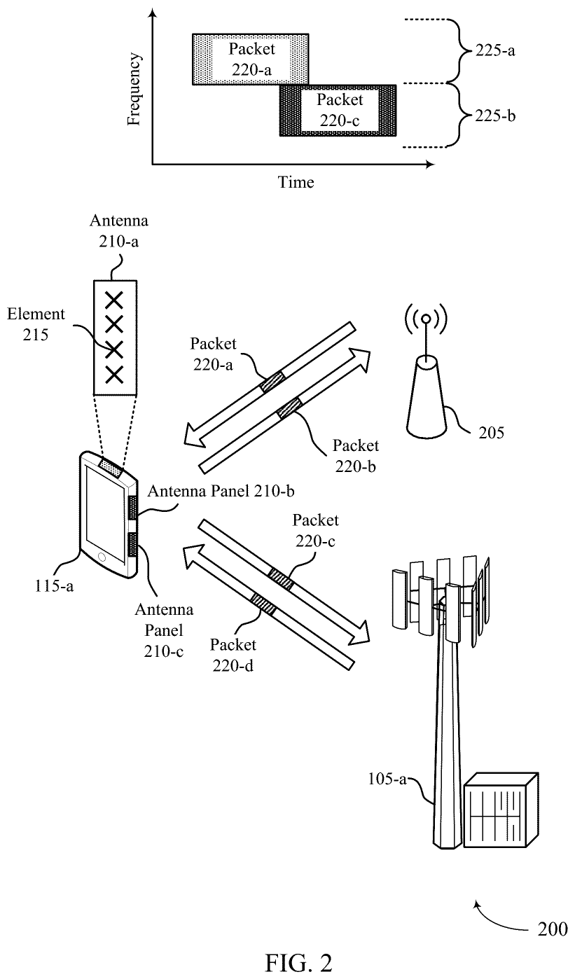

FIG. 2 shows an example of a wireless communications system 200 that supports multi-RAT antenna management in accordance with one or more aspects of the present disclosure. In some examples, the wireless communications system 200 may implement aspects of a wireless communications system 100. For example, the wireless communications system 200 may include a UE 115-a which may be an example of a UE 115 as described with reference to FIG. 1. Further, the wireless communications system 200 may include a network entity 105-a which may be an example of a network entity 105 as described with reference to FIG. 1.

In some examples, the UE 115-a may support multiple RATs. For example, the UE 115-a may support a first RAT and in addition, support a second RAT. In one example, the first RAT may include wireless local area network (WLAN) and the second RAT may include wireless wide area network (WWAN). Using WLAN, the UE 115-a may connect with other devices over shorter distances using unlicensed spectrum. While utilizing WLAN, the UE 115-a may establish a connection with an AP 205 which may act a basic service area (BSA) for the UE 115-a and connect to other devices using the AP 205. Alternatively, using WWAN, the UE 115-a may connect to other devices over longer distances using licensed spectrum. While communicating using WWAN, the UE 115-a may establish a connection with a network entity 105-a and connect to other devices using the network entity 105-a. Other examples of RATs may include Bluetooth (BT), BT low energy (BLE), Ultra-wideband (UWB), ambient IoT technology (e.g., RF identification (RFID) tags), location technology (e.g., global navigation satellite system (GNSS), satellite, or global positioning system (GPS)), among others.

In some examples, each RAT may operate according to a specific frequency range. For example, WLAN may support five distinct frequency ranges that include a 2.4 GHz range (e.g., channels 1-13), a 3.6 GHz range, a 4.9 GHz range, a 5 GHz range, and a 5.9 GHz range. On the other hand, BT or BLE may support a frequency range of 2.400 GHz to 2.4835 GHz. Further, WWAN may support multiple frequency bands (e.g., 43 LTE bands) that each span a range of frequency and UWB may support multiple channels (e.g., 15 channels) that span a frequency range of 3.1 GHz to 10.6 GHz.

To support multiple RATs, the UE 115-a may include one or more antenna panels 210 for each RAT, and each antenna panel 210 may include multiple antenna elements 215. For example, as shown in FIG. 2, the UE 115-a may include an antenna panel 210-a, an antenna panel 210-b, and an antenna panel 210-c. The antenna panel 210-a may support the first RAT or a frequency range corresponding to the first RAT and both the antenna panel 210-b and the antenna panel 210-c may support the second RAT or a frequency range corresponding to the second RAT.

Distances between antennas panels 210 corresponding to different RATs may be different. For example, a first distance between the antenna panel 210-a and the antenna panel 210-b may be less than a second distance between the antenna panel 210-a and the antenna panel 210-c. In some examples, antenna panels 210 corresponding to different RATs may be included in a same antenna cluster. Such distances may be a factor in the isolation level between two antenna panels 210. For instance, two antenna panels 210 may have a higher isolation level if the distance between the antenna panels 210 exceeds a threshold and may have a lower isolation level if the distance between the antenna panels 210 falls below the threshold.

In one example, the first RAT may include WLAN and the second RAT may include WWAN. The UE 115-a may tune an antenna panel 210 (e.g., the antenna panel 210-a) to a WLAN supported frequency range and communicate one or more packets 220 to the AP 205. For example, the UE 115-a may receive the packet 220-a from the AP 205 or the UE 115-a may transmit the packet 220-b to the AP 205 using the antenna panel 210. While WLAN is enabled, the UE 115-a may additionally tune an antenna panel 210 (e.g., the antenna panel 210-b or the antenna panel 210-c) to a WWAN supported frequency range and communicate one or more packets 220 to the network entity 105-a. For example, the UE 115-a may transmit the packet 220-c to the network entity 105-a or the UE 115-a may receive the packet 220-d from the network entity 105-a.

However, in some cases, the frequency range corresponding to the first RAT and the frequency range corresponding to the second RAT may be directly adjacent to one another. For example, the UE 115-a may tune an antenna panel 210 to a WLAN supported frequency range that includes the 2.4 GHz range (2.4000 GHz to 2.4835 GHZ) and the UE 115-a may tune a different antenna panel 210 to a WWAN supported frequency range that includes band 40 (2.300 GHz to 2.400 GHz) or band 41 (2.496 GHz to 2.690 GHz). Further, if the antenna panels 210 corresponding to the different RATs do not have a sufficient level of isolation between each other (e.g., isolation level is below a threshold) or are not separated by a sufficient distance (e.g., if the antenna panels 210 are in a same antenna cluster), the UE 115-a may experience interference when simultaneously communicating using the antenna panels 210.

For example, during a first duration and using the antenna panel 210-b tuned to a frequency range 225-b (e.g., band 40), the UE 115-a may transmit the packet 220-c and during a second duration that at least partially overlaps the first duration and using the antenna panel 210-a tuned to the frequency range 225-a (e.g., 2.4 GHz range), the UE 115-a may receive the packet 220-a from the AP 205. Because the antenna panel 210-a and the antenna panel 210-b do not have sufficient isolation (e.g., due to distance or other characteristics) and because the frequency range 225-a and the frequency range 225-b are adjacent to one another, the transmission of the packet 220-c using the antenna panel 210-b (e.g., aggressor antenna panel 210) may interfere with the reception of the packet 220-a using the antenna panel 210-a (e.g., victim antenna panel 210).

Using other methods, the UE 115-a may detect that both RATs are active and mitigate interference between antenna panels 210 corresponding to the RATs based on this detection. As an example, the UE 115-a may activate the second RAT (e.g., WWAN) and determine whether the first RAT (e.g., WLAN, BT, or BLE) is also active based on user inputs from a graphical user interface (GUI) of the UE 115-a. User inputs may include an enabled state or a disabled stated for the first RAT. If the user input includes the enabled state for the first RAT, the UE 115-a may determine that both RATs are active and may perform a mitigation procedure (e.g., refrain from using the aggressor antenna panel 210). However, although the first RAT may be enabled, a traffic level of communications using the first RAT may vary. For example, in the enabled state, the UE 115-a may be connected to the AP 205, but may not have any pending data to send or receive. In such example, transmissions using the antenna panel 210 corresponding to the second RAT may not cause interference and performing such mitigation procedure in this scenario may result in an inefficient use of communication resources.

As described herein, the UE 115-a may utilize traffic information to mitigate interference between antenna panels 210 corresponding to different RATs. In some examples, the UE 115-a may enable the first RAT (e.g., BLE, BT, WLAN, or UWB) and in addition, enable a second RAT (e.g., WWAN). Further, the UE 115-a may tune the antenna panel 210-a to the frequency range 225-a associated with the first RAT and the antenna panel 210-b to the frequency range 225-b associated with the second RAT. Upon determining that the frequency range 225-a and the frequency range 225-b are adjacent to one another, the UE 115-a may monitor a traffic level of communications using an antenna panel 210 of a prioritized RAT. In the example of FIG. 2, the first RAT may correspond to a higher priority than the second RAT and as such, the UE 115-a may monitor a traffic level of communications using the antenna panel 210-a that corresponds to the first RAT.

The traffic level of the first RAT may refer to a quantity of packets 220 (e.g., packets 220-a and packets 220-b) exchanged (e.g., transmitted or received) by the UE 115-a over a duration using the antenna panel 210-a. Upon determining the traffic level, the UE 115-a may compare the traffic level to a threshold. If the traffic level exceeds the threshold (and the first RAT is enabled via the GUI), the UE 115-a may determine that the UE 115-a is frequently communicating using the antenna panel 210-a and a risk for interference from communicating using the antenna panel 210-b is high (e.g., the risk is above a threshold risk level). Upon determining that the traffic level exceeds the threshold, the UE 115-a may activate a more isolated antenna panel 210 (e.g., an antenna panel 210 having an isolation level above a threshold) for communications using the second RAT. For example, the UE 115-a may deactivate the antenna panel 210-b for communications using the second RAT and activate the antenna panel 210-c for communications using the second RAT. An isolation level between the antenna panel 210-a and the antenna panel 210-c may be more than an isolation level between the antenna panel 210-a and the antenna panel 210-b. Thus, activating the antenna panel 210-c may mitigate or reduce the interference experienced by the victim antenna panel (e.g., the antenna panel 210-a).

Alternatively, if the traffic level is below the threshold (and the first RAT is enabled via the GUI), the UE 115-a may determine that the UE 115-a has a relatively low amount of data to communicate using the antenna panel 210-a and that the risk for interference from communicating using the antenna panel 210-b is low (e.g., the risk falls below a threshold risk level). Upon determining that the traffic level is below the threshold, the UE 115-a may not restrict the selection of the antenna panel 210 used for communicating packets 220 using the second RAT. The UE 115-a may continue using the antenna panel 210-b for communications using the second RAT or activate any other antenna panels 210 for communications using the second RAT. Using the methods as described herein may allow a UE 115-a to support multiple RATs without interference between antenna panels 210 corresponding to different RATs of the multiple RATs.

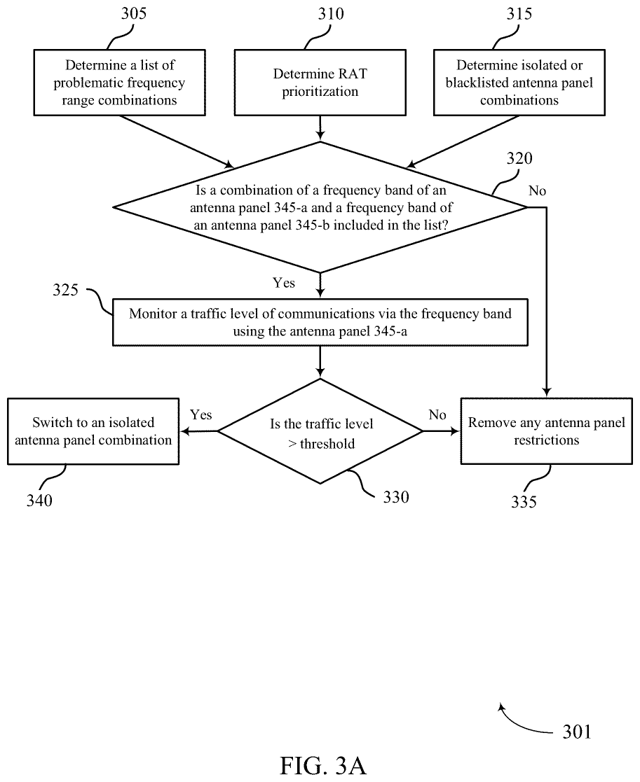

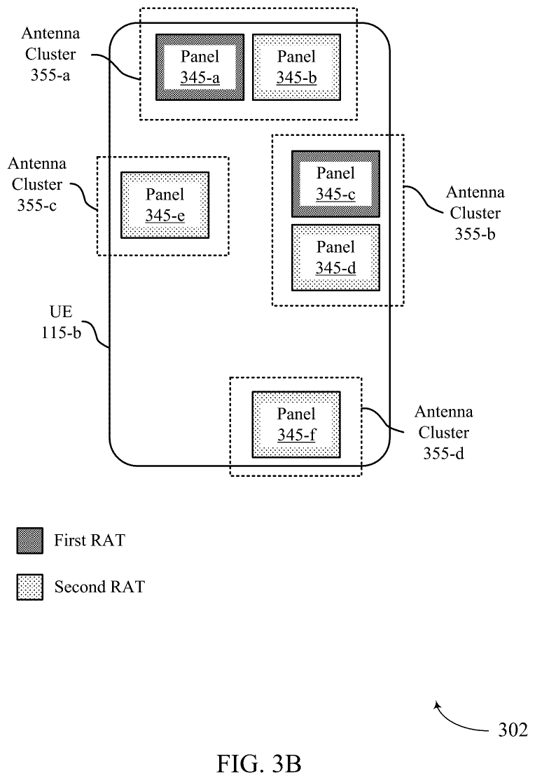

FIGS. 3A and 3B show examples of a flow diagram 301 and a system 302 that support multi-RAT antenna management in accordance with one or more aspects of the present disclosure. In some examples, the flow diagram 301 may be implemented by aspects of a wireless communications system 100 and a wireless communications system 200. For example, the flow diagram 301 may be implemented by a UE 115 as described with reference to FIGS. 1 and 2. The system 302 may include aspects of a wireless communications system 100 and a wireless communications system 200. For example, the system 302 may include a UE 115-b, which may be an example of a UE 115 as described with reference to FIGS. 1 and 2.

As shown in FIG. 3B, the UE 115-b may include multiple antenna panels 345. In some examples, different sets of one or more antenna panels 345 may support different frequency ranges. For example, the antenna panel 345-a and the antenna panel 345-c may support a first frequency range associated with a first RAT (e.g., WLAN, BLE, BT, or UWB) and the antenna panel 345-b, the antenna panel 345-d, the antenna panel 345-e, and the antenna panel 345-f may support a second frequency range associated with a second RAT (e.g., WWAN). Further, the antenna panels 345 may be separated into antenna clusters 355. An antenna cluster 355 may refer to a group of one or more antenna panels 345 that share one or more components and are physically located next to one another. In the example of FIG. 3B, the antenna cluster 355-a may include at least the antenna panel 345-a and the antenna panel 345-b, the antenna cluster 355-b may include at least the antenna panel 345-c and the antenna panel 345-d, the antenna cluster 355-c may include at least the antenna panel 345-e, and the antenna cluster 355-d may include at least the antenna panel 345-f.

In accordance with the flow diagram 301 of FIG. 3A, the UE 115-b (or a co-existence manager of the UE 115-b) may perform co-existence RAT mitigation management. At 305, the UE 115-b may determine or generate a list of problematic frequency range combinations. An example of problematic frequency range combination may be two frequency ranges that overlap, are adjacent to, are a harmonic order to, or are an intermodulation order to one another. For example, a problematic frequency range combination in the list may include a band 40 for WWAN and a channel 1 for WLAN. As another example, a problematic frequency range combination may include a band 104 for WWAN and a channel 8 for UWB. Additionally or alternatively, at 310, the UE 115-b may determine RAT prioritization. For example, the UE 115-b may determine that a first priority associated with the first RAT (e.g., WLAN, BLE, BT, or UWB) is higher than a second priority associated with the second RAT (e.g., WWAN).

Additionally or alternatively, at 315, the UE 115-b (or a co-existence manager of the UE 115-b) may determine a list of isolated antenna panel combinations or a blacklist of antenna panel combinations. Isolated antenna panel combinations may be pairs of antenna panels 345 corresponding to different RATs that do not cause interference when operating via the problematic frequency ranges and blacklisted antenna panel combinations may be pairs of antenna panels 345 corresponding to different RATs that do cause interference when operating via the problematic frequency ranges. In some examples, the list may include different isolated antenna panel combinations or blacklisted antenna panel combinations for different problematic frequency ranges.

In some examples, the UE 115-b may generate the list of isolated antenna panel combinations or the list of blacklisted antenna panel combinations based on a physical distance between the antenna panels 345. For example, the list of isolated antenna panel combinations may include pairs of antenna panels 345 that are located at least a first distance away from each other to allow for space-division multiplexing (SDM). The first distance may be greater than a distance between antenna panels 345 in a same antenna cluster 355. Thus, in some examples, an isolated antenna panel combination may refer to a pair of antenna panels 345 that are not located within a same antenna cluster 355 (e.g., the antenna panel 345-a and the antenna panel 345-f or the antenna panel 345-c and the antenna panel 345-f).

Alternatively, the list of blacklisted antenna panel combinations may include pairs of antenna panels 345 that are located at most a second distance (e.g., shorter than the first distance) away from each other which doesn't allow for SDM. In some examples, the second distance may be equal to or less than the distance between antenna panels 345 in a same antenna cluster 355. Thus, a blacklisted antenna panel combination may refer to a pair of antenna panels 345 that are located within a same antenna cluster 355 (e.g., the antenna panel 345-a and the antenna panel 345-b or the antenna panel 345-c and the antenna panel 345-d).

In another example, the UE 115-b may generate the list of isolated antenna panel combinations or the list of blacklisted antenna panel combinations based on prior isolation or interference measurements. For example, prior to 315, the UE 115-b may measure a level of isolation between the antenna panel 345-a and the antenna panel 345-d. Antenna isolation is the measure of how easily one antenna will pick up radiation from another antenna and may be measured in units of decibel (dB). If the isolation level is below a threshold, the UE 115-b may conclude that interference for the given antenna panel combination is occurring and insert the combination (e.g., the antenna panel 345-a and the antenna panel 345-d) in the blacklisted antenna panel. Alternatively, if the isolation does exceed the threshold (e.g., 20 dB), the UE 115-b may conclude that interference for the given antenna panel combination is not occurring and insert the combination (e.g., the antenna panel 345-a and the antenna panel 345-d) in the list of isolated antenna panel combinations.

In some examples, the UE 115-b may store the list of blacklisted antenna panel combinations or the list of isolated antenna panel combination in a non-volatile memory of the coexistence manager of the UE 115-b. Table 1 illustrates an example of a list of blacklisted antenna panel combinations when the first RAT equals WLAN and the second RAT equals WWAN. Table 2 illustrates an example of a list of blacklisted antenna panel combinations when the first RAT equals UWB and the second RAT equals WWAN.

TABLE 1
Blacklisted Antenna Combinations.

| WLAN 2.4 GHz | | Current WLAN | Blacklisted |
|---|---|---|---|
| Info | WWAN Info | Antenna Panel | WWAN Antenna |
| WLAN 2.4 GHz | LTE: Band B41 | Panel 345-a | Panel 345-b and |
| Channel 13 | | | Panel 345-d |
| WLAN 2.4 GHz | NR: Band N41 | Panel 345-a | Panel 345-b and |
| Channel 13 | | | Panel 345-d |
| WLAN 2.4 GHz | LTE: Band B40 | Panel 345-a | Panel 345-b and |
| Channel 1 | | | Panel 345-d |
| WLAN 2.4 GHz | NR: Band N40 | Panel 345-a | Panel 345-b and |
| Channel 1 | | | Panel 345-d |

TABLE 2
Blacklisted Antenna Combinations.

| | | Current UWB | Blacklisted |
|---|---|---|---|
| UWB Info | WWAN Info | Antenna Panel | WWAN Antenna |
| UWB Channel 8 | NR: Band N104 | Panel 345-a | Panel 345-b and |
| | | | Panel 345-d |

In some cases, the UE 115-b may select the antenna panel 345-a for communications via the first RAT and select the antenna panel 345-b for communications via the second RAT. In such example, the UE 115-b may tune the antenna panel 345-a to the first frequency range associated with the first RAT and tune the antenna panel 345-b to the second frequency range associated with the second RAT. Upon selection of the antenna panel 345-a and the antenna panel 345-b and at 320, the UE 115-b (or a co-existence manager of the UE 115-b) may determine whether the first frequency range and the second frequency range fall within the problematic frequency ranges determined at 305 (e.g., overlap, are adjacent to one another, or may otherwise cause interference to one another). If the first frequency range and the second frequency range do not fall within the problematic frequency ranges, the UE 115-b may continue to 335. Alternatively, if the first frequency range and the second frequency range do fall within the problematic frequency ranges, the UE 115-b may continue to 325.

At 335, the UE 115-b (or a co-existence manager of the UE 115-b) may select any antenna panel 345 capable of supporting the first frequency range (e.g., the antenna panel 345-a or the antenna panel 345-c) for communications via the first RAT without restriction and may select any antenna panel 345 capable of supporting the second frequency range (e.g., the antenna panel 345-b, the antenna panel 345-d, the antenna panel 345-e, or the antenna panel 345-f) for communications via the second RAT without restriction. In other words, the UE 115-b may remove any sort of restriction when selecting antenna panels 345 for communication via the first RAT or the second RAT.

At 325, the UE 115-b (or a co-existence manager of the UE 115-b) may monitor a traffic level of communications associated with the higher priority RAT. For example, the UE 115-b may monitor a traffic level of communications via the first frequency band associated with the first RAT using the antenna panel 345-a. In some examples, the UE 115-b may monitor a quantity of packets transmitted or received by the UE 115-b via the first frequency band using the antenna panel 345-a during a duration (e.g., 100 ms or 500 ms) and the traffic level may include the quantity of packets. In some examples, the quantity of packets may be a number of packets communicated over the wireless coexistence interface 2 (WCI-2) interface. In some examples, the traffic level may be expressed as a percentage. For example, the traffic level may include the quantity of packets received or transmitted over the duration divided by a total quantity of possible packets (e.g., a maximum number of packets) that may be transmitted or received over the duration.

At 330 and upon determining the traffic level, the UE 115-b (or a co-existence manager of the UE 115-b) may compare the traffic level to a threshold. In some examples, the traffic threshold may be expressed as a quantity of packets or as a percentage (e.g., 20%). If the traffic level exceeds the threshold, the UE 115-b may continue to 340. Alternatively, if the traffic level does not exceed the threshold, the UE 115-b may continue to 335.

At 340, the co-existence manager of the UE 115-b may inform the UE 115-b to switch from using the antenna panel 345-b for communications via the second frequency range associated with the second RAT to using an antenna panel 345 included in the isolated list of antenna panel combinations or an antenna panel 345 not included in the blacklisted list of antenna panel combinations that is paired with the antenna panel 345-a. For example, if the isolated list of antenna panel combinations includes the antenna panel 345-a and the antenna panel 345-f, the UE 115-b may select the antenna panel 345-f for future communications via the second frequency range associated with the second RAT. In some examples, the UE 115-b (or the co-existence manager if the UE 115-b) may utilize the code presented in Table 3 to perform 330, 335, and 340.

TABLE 3
Co-existence Manager Code.

```
IF second frequency range with PCC/SCC carrier activated
  IF the first frequency range and the second frequency range are
  problematic
  && the traffic level associated with the first RAT above a threshold is
  TRUE
    select second RAT antenna panel from isolated antenna panel
    combinations or select second RAT antenna panel from second RAT
    antenna panels not included in the blacklisted antenna panel
    combinations
  ELSE
    select any second RAT antenna panel without restriction
  END
END
```

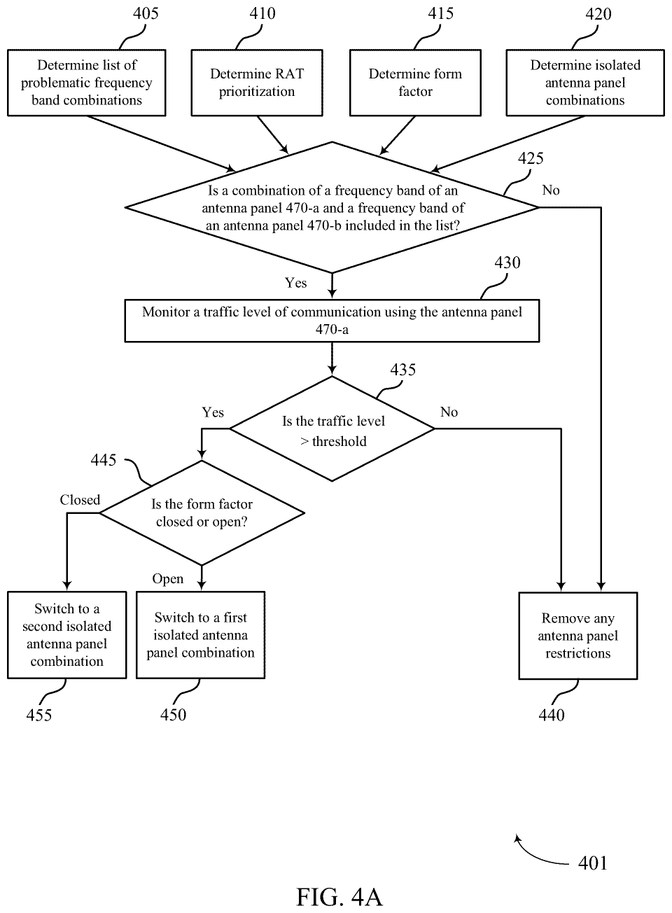

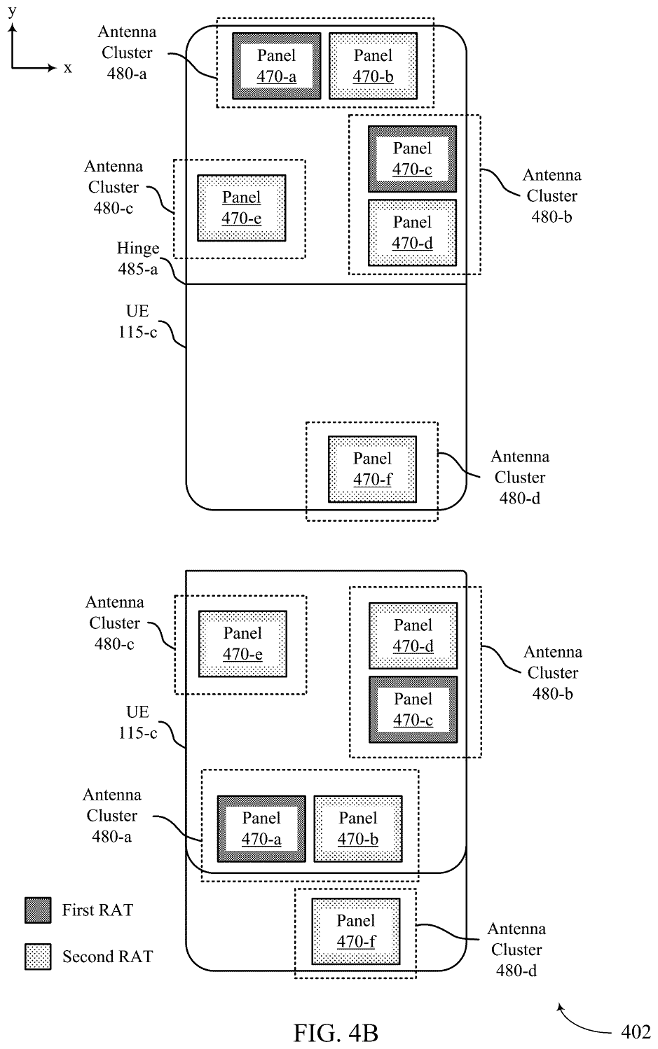

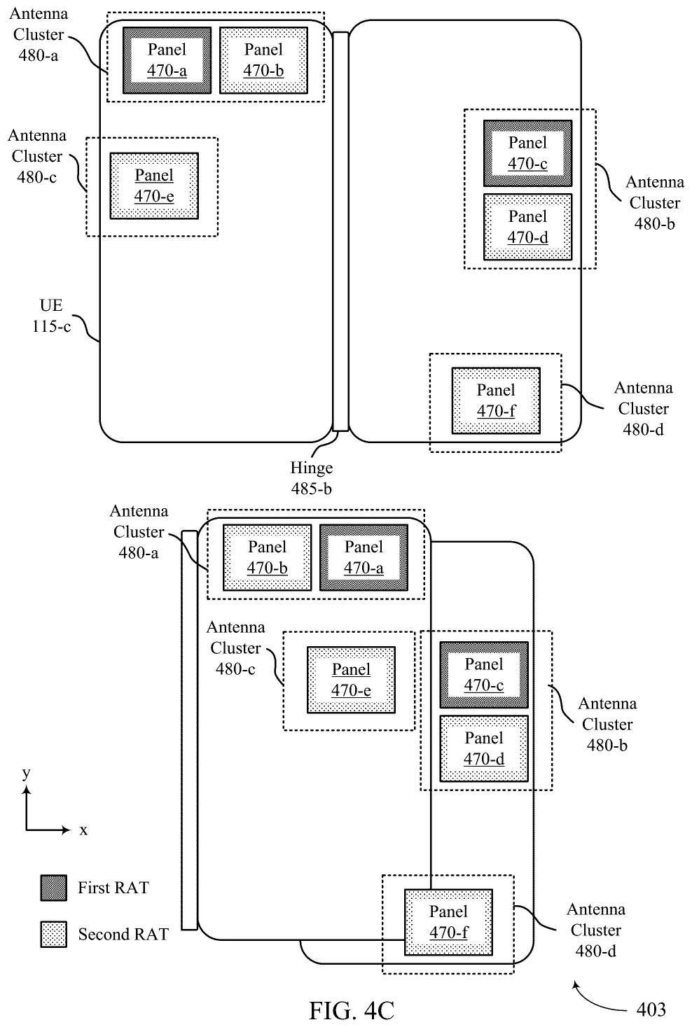

FIGS. 4A, 4B, and 4C show examples of a flow diagram 401, a system 402, and a system 403 that support multi-RAT antenna management in accordance with one or more aspects of the present disclosure. In some examples, the flow diagram 401 may be implemented by aspects of a wireless communications system 100 and a wireless communications system 200. For example, the flow diagram 401 may be implemented by a UE 115 as described with reference to FIGS. 1 and 2. The system 402 and the system 403 may include aspects of a wireless communications system 100 and a wireless communications system 200. For example, the system 402 and the system 403 may include a UE 115-c which may be an example of a UE 115 as described with reference to FIGS. 1 and 2.

As shown in FIG. 4B and FIG. 4C, the UE 115-c may include multiple antenna panels 470. In some examples, different sets of one or more antenna panels 470 may support different frequency ranges. For example, the antenna panel 470-a and the antenna panel 470-c may support a first frequency range associated with a first RAT (e.g., WLAN, BLE, BT, or UWB) and the antenna panel 470-b, the antenna panel 470-d, the antenna panel 470-e, and the antenna panel 470-f may support a second frequency range associated with a second RAT (e.g., WWAN). Further, the antenna panels 470 may be separated into antenna clusters 480. An antenna cluster 480 may refer to a group of one or more antenna panels 470 that share one or more components and are physically located next to one another. In the example of FIG. 4B and FIG. 4C, the antenna cluster 480-a may include at least the antenna panel 470-a and the antenna panel 470-b, the antenna cluster 480-b may include at least the antenna panel 470-c and the antenna panel 470-d, the antenna cluster 480-c may include at least the antenna panel 470-e, and the antenna cluster 480-d may include at least the antenna panel 470-f.

In some examples, the UE 115-c may exist in multiple form factor states. For example, as shown in FIG. 4B, the UE 115-c may include a hinge 485-a situated in the middle of the UE 115-c along the x-axis resulting in a first form factor state (e.g., an open state) or a second form factor state (e.g., a closed state). Alternatively, as shown in FIG. 4C, the UE 115-c may include a hinge 485-b situated along the edge of the UE 115-c along the y-axis resulting in the first factor state (e.g., an open state) or the second form factor state (e.g., a closed state).

In some examples, the form factor state of the UE 115-c may affect the physical spacing or isolation level between antenna panels 470. For example, in FIG. 4B and in the first form factor state, the antenna panel 470-a may be a first distance away from the antenna panel 470-f and in the second form factor state, the antenna panel 470-b may be a second distance away from the antenna panel 470-f, the second distance being shorter than the first distance. As another example, in FIG. 4C and in the first form factor state, the antenna panel 470-c may be a first distance away from the antenna panel 470-e and in the second form factor state, the antenna panel 470-c may be a second distance away from the antenna panel 470-e, the second distance being shorter than the first distance.

In accordance with the flow diagram 401 of FIG. 4A, the UE 115-c (or a co-existence manager of the UE 115-c) may perform co-existence RAT mitigation management. At 405, the UE 115-c may determine or generate a list of problematic frequency range combinations. An example of a problematic frequency range combination may be two frequency ranges that overlap, are adjacent to, are a harmonic order to, or are an intermodulation order to one another. For example, a problematic frequency range combination in the list may include a band 40 for WWAN and a channel 13 for WLAN. As another example, a problematic frequency range combination may include a band 104 for WWAN and a channel 8 for UWB. Additionally or alternatively, at 410, the UE 115-c may determine RAT prioritization. For example, the UE 115-c may determine that a first priority associated with the first RAT (e.g., WLAN, BLE, BT, or UWB) is higher than a second priority associated with the second RAT (e.g., WWAN). Additionally or alternatively, at 415, the UE 115-c may determine whether the UE 115-c is in the first form factor state or the second form factor state.

Additionally or alternatively, at 420, the UE 115-c (or a co-existence manager of the UE 115-c) may determine a list of isolated antenna panel combinations or blacklist of antenna panel combinations for each form factor state of the UE 115-c. For example, the UE 115-c may determine a first list of isolated or blacklisted antenna panel combinations for the first form factor and a second list of isolated or blacklisted antenna panel combinations for the second form factor pair. Isolated antenna panel combinations corresponding to a respective form factor state may include pairs of antenna panels 470 corresponding to different RATs that do not cause interference when operating via the problematic frequency ranges while the UE 115-c is in the respective form factor state and blacklisted antenna panel combinations corresponding to a respective form factor state may be pairs of antenna panels 470 corresponding to different RATs that do cause interference when operating via the problematic frequency ranges while the UE 115-c is in the respective form factor state. In some examples, the lists may include different isolated antenna panel combinations or blacklisted antenna panel combinations for different problematic frequency ranges.

In some examples, the UE 115-c may generate the first list and the second list of isolated antenna panel combinations or the first list or the second list of blacklisted antenna panel combinations based on a physical distance between the antenna panels 470. For example, the first list and the second list of isolated antenna panel combinations may include pairs of antenna panels 470 that are located at least a third distance away from each other to allow for SDM. The third distance may be greater than a distance between antenna panels 470 in a same antenna cluster 480. Thus, in some examples, an isolated antenna panel combination may refer to a pair of antenna panels 470 that are not located within a same antenna cluster 480. In the example of FIG. 4B, the first list of isolated antenna panel combinations may include the antenna panel 470-a and the antenna panel 470-f or the antenna panel 470-c and the antenna panel 470-f and the second list of isolated antenna panel combinations may include the antenna panel 470-a and the antenna panel 470-c. The second list of isolated antenna panels may not include the antenna panel 470-a and the antenna panel 470-f because, in FIG. 4B, the second factor state, the distance between the antenna panel 470-a and the antenna panel 470-f may not exceed or be equal to the third distance.

Alternatively, the first list and the second list of blacklisted antenna panel combinations may include pairs of antenna panels 470 that are located at most a fourth distance (e.g., shorter than the third distance) away from each other which doesn't allow for SDM. In some examples, the fourth distance may be equal to or less than the distance between antenna panels 470 in a same antenna cluster 480. Thus, a blacklisted antenna panel combination may refer to a pair of antenna panels 470 that are located within a same antenna cluster 480. In the example of FIG. 4B, the first list of blacklisted antenna panel combinations may include the antenna panel 470-a and the antenna panel 470-b or the antenna panel 470-c and the antenna panel 470-d and the second list of blacklisted antenna panel combinations may include the antenna panel 470-a and the antenna panel 470-b or the antenna panel 470-a and the antenna panel 470-f. The second list of blacklisted antenna panels may include the antenna panel 470-a and the antenna panel 470-f because in the second form factor state, the distance between the antenna panel 470-a and the antenna panel 470-f does not exceed the fourth distance.

In another example, the UE 115-c may generate the lists of isolated antenna panel combinations or the lists of blacklisted antenna panel combinations based on prior isolation or interference measurements. For example, while in the first form factor state and prior to 415, the UE 115-c may measure a level of isolation between the antenna panel 470-a and the antenna panel 470-d. If the isolation level is below a threshold, the UE 115-c may conclude that interference for the given antenna panel combination is occurring and insert the combination (e.g., the antenna panel 470-a and the antenna panel 470-d) into the first list of blacklisted antenna panels. Alternatively, if the isolation level does exceed the threshold, the UE 115-c may conclude that interference for the given antenna panel combination is not occurring and insert the combination (e.g., the antenna panel 470-a and the antenna panel 470-d) in the first list of isolated antenna panel combinations. A similar procedure may be performed while the UE 115-c is in the second form factor state. In some examples, the UE 115-c may store the lists of blacklisted antenna panel combinations or the lists of isolated antenna panel combination in a non-volatile memory of the coexistence manager of the UE 115-c. Table 4 illustrates an example of a first list of blacklisted antenna panel combinations for FIG. 4B when the first RAT equals WLAN and the second RAT equals WWAN. Table 5 illustrates the second list of blacklisted antenna panel combinations for FIG. 4B when the first RAT equals WLAN and the second RAT equals WWAN.

TABLE 4
Open State Blacklisted Antenna Combinations.
Open State

| | | | Blacklisted |
|---|---|---|---|
| WLAN 2.4 GHz | | Current WLAN | WWAN |
| Info | WWAN Info | Antenna Panel | Antenna |
| WLAN 2.4 GHz | LTE: Band B41 | Panel 470-a | Panel 470-b and |
| Channel 13 | | | Panel 470-d |
| WLAN 2.4 GHz | NR: Band N41 | Panel 470-a | Panel 470-b and |
| Channel 13 | | | Panel 470-d |
| WLAN 2.4 GHz | LTE: Band B40 | Panel 470-a | Panel 470-b and |
| Channel 1 | | | Panel 470-d |
| WLAN 2.4 GHz | NR: Band N40 | Panel 470-a | Panel 470-b and |
| Channel 1 | | | Panel 470-d |

TABLE 5
Closed State Blacklisted Antenna Combinations.
Closed State

| | | Current | |
|---|---|---|---|
| | | WLAN | Blacklisted |
| WLAN 2.4 GHz | | Antenna | WWAN |
| Info | WWAN Info | Panel | Antenna |
| WLAN 2.4 GHz | LTE: Band B41 | Panel 470-a | Panel 470-f, |
| Channel 13 | | | Panel 470-b, and |
| | | | Panel 470-d |
| WLAN 2.4 GHz | NR: Band N41 | Panel 470-a | Panel 470-f, Panel |
| Channel 13 | | | 470-b, and Panel |
| | | | 470-d |
| WLAN 2.4 GHz | LTE: Band B40 | Panel 470-a | Panel 470-f, Panel |
| Channel 1 | | | 470-b, and Panel |
| | | | 470-d |
| WLAN 2.4 GHz | NR: Band N40 | Panel 470-a | Panel 470-f, Panel |
| Channel 1 | | | 470-b, and Panel |
| | | | 470-d |

In some cases, the UE 115-c may select the antenna panel 470-a for communications via the first RAT and select the antenna panel 470-b for communications via the second RAT. In such example, the UE 115-c may tune the antenna panel 470-a to the first frequency range associated with the first RAT and tune the antenna panel 470-b to the second frequency range associated with the second RAT. Upon selection of the antenna panel 470-a and the antenna panel 470-b and at 425, the UE 115-c (or a co-existence manager of the UE 115-c) may determine whether the first frequency range and the second frequency range fall within the problematic frequency ranges determined at 405 (e.g., overlap or are adjacent to one another). If the first frequency range and the second frequency range do not fall within the problematic frequency ranges, the UE 115-c may continue to 440. Alternatively, if the first frequency range and the second frequency range do fall within the problematic frequency ranges, the UE 115-c may continue to 430.

At 440, the UE 115-c (or a co-existence manager of the UE 115-c) may select any antenna panel 470 capable of supporting the first frequency range (e.g., the antenna panel 470-a or the antenna panel 470-c) for communications via the first RAT without restriction and may select any antenna panel 470 capable of supporting the second frequency range (e.g., the antenna panel 470-b, the antenna panel 470-d, the antenna panel 470-e, or the antenna panel 470-f) for communications via the second RAT without restriction. In other words, the UE 115-c may remove any sort of restriction when selecting antenna panels 470 for communication via the first RAT or the second RAT.

At 430, the UE 115-c (or a co-existence manager of the UE 115-c) may monitor a traffic level of communications associated with the higher priority RAT. For example, the UE 115-c may monitor a traffic level of communications via the first frequency band associated with the first RAT using the antenna panel 470-a. In some examples, the UE 115-c may monitor a quantity of packets transmitted or received by the UE 115-c via the first frequency band using the antenna panel 470-a during a duration (e.g., 100 ms or 500 ms) and the traffic level may include the quantity of packets. In some examples, the quantity of packets may be a number of packets communicated over the WCI-2 interface. In some examples, the traffic level may be expressed as a percentage. For example, the traffic level may include the quantity of packets received or transmitted over the duration divided by a total quantity of possible packets (e.g., a maximum number of packets) that may be transmitted or received over the duration.

At 435 and upon determining the traffic level, the UE 115-c (or a co-existence manager of the UE 115-c) may compare the traffic level to a threshold. In some examples, the traffic threshold may be expressed as a quantity of packets or a percentage (e.g., 20%). If the traffic level exceeds the threshold, the UE 115-c may continue to 445. Alternatively, if the traffic level does not exceed the threshold, the UE 115-c may continue to 440.

At 445, the UE 115-c may determine whether the UE 115-c is in the first form factor state or the second form factor state (e.g., based on the determination at 415). If the UE 115-c is in the open state, the UE 115-c may continue to 450. Alternatively, if the UE 115-c is in the closed state, the UE 115-c may continue to 455.

At 450, the co-existence manager of the UE 115-c may inform the UE 115-c to switch from using the antenna panel 470-b for communications via the second frequency range associated with the second RAT to using an antenna panel 470 included in the first list of isolated antenna panel combinations or an antenna panel 470 not included in first list of blacklisted list of antenna panel combinations that is paired with the antenna panel 470-a. For example, if the first list of isolated antenna panel combinations includes the antenna panel 470-a and the antenna panel 470-f, the UE 115-c may select the antenna panel 470-f for future communications via the second frequency range associated with the second RAT.

At 455, the co-existence manager of the UE 115-c may inform the UE 115-c to switch from using the antenna panel 470-b for communications via the second frequency range associated with the second RAT to using an antenna panel 470 included in the second list of isolated antenna panel combinations or an antenna panel 470 not included in first list of blacklisted list of antenna panel combinations that is paired with the antenna panel 470-a. For example, if the second list of isolated antenna panel combinations includes the antenna panel 470-a and the antenna panel 470-c, the UE 115-c may select the antenna panel 470-c for future communications via the second frequency range associated with the second RAT.

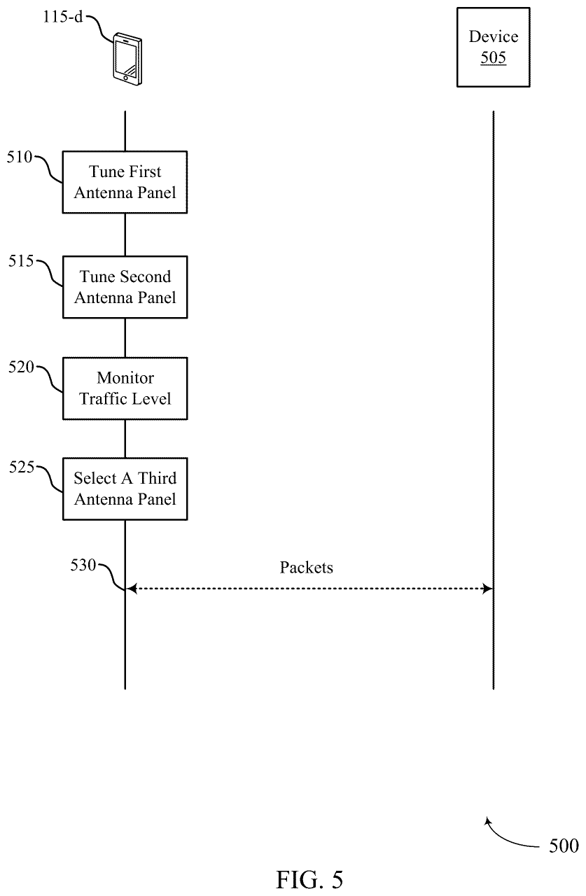

FIG. 5 shows an example of a process flow 500 that supports multi-RAT antenna management in accordance with one or more aspects of the present disclosure. In some examples, the process flow 500 may implement, or be implemented by, aspects of a wireless communications system 100 and a wireless communications system 200. For example, the process flow 500 may be performed by a UE 115-d which may be an example of a UE 115 as described with reference to FIGS. 1 and 2. Alternative examples of the following may be implemented, where some steps are performed in a different order then described or are not performed at all. In some cases, steps may include additional features not mentioned below, or further steps may be added.

In some examples, the UE 115-d may include multiple antenna panels. For example, the UE 115-d may include antenna panels supportive of a first frequency band associated with a first RAT and antenna panels supportive of a second frequency band associated with a second RAT. In some examples, the UE 115-d may perform isolation measurements for antenna panels of different pairs of antenna panels included in the multiple antenna panels, where each pair of antenna panels includes an antenna panel associated with the first RAT and an antenna panel associated with the second RAT. Based on the isolation measurements, the UE 115-d may generate a first list of antenna panels, a second list of antenna panels, or both. The first list may include antenna panels associated with the second RAT and correspond to antenna panel pairs that do not exceed a threshold isolation level. The second list may include antenna panels associated with the second RAT and correspond to antenna panel pairs that exceeds the threshold isolation level.

At 510, the UE 115-d may tune a first antenna panel to the first frequency band associated with the first RAT and at 515, the UE 115-d may tune a second antenna panel to the second frequency band associated with the second RAT. In some examples, the first RAT may be associated with higher priority than the second RAT. Further, an example of the first RAT may be WLAN, BT, BLE, or UWB and an example of the second RAT may be WWAN.

At 520, the UE 115-d may monitor a traffic level of communications via the first frequency band associated with the first RAT. The UE 115-d may monitor the traffic level based on the first frequency band overlapping or being adjacent to the second frequency band. In some examples, monitoring the traffic level may include the UE 115-d monitoring a quantity of packets communicated via the first frequency band associated with the first RAT within a time window.

At 525, the UE 115-d may select a third antenna panel for communications via the second frequency band based on the traffic level and an isolation level between the first antenna panel and the second antenna panel. In some examples, the UE 115-d may select the third antenna panel from the second list or exclusive of the first list. Alternatively, the UE 115-d may select any antenna panel from the antenna panels associated with the second RAT based on the traffic level being below the threshold traffic level. Further, the UE 115-d may select the third antenna panel based on a form factor state of the UE 115-d. The form factor state may include an open state or a closed state.

At 530, the UE 115-d may communicate packets to the device 505 (e.g., a network entity) using the selected third antenna associated with the second RAT.

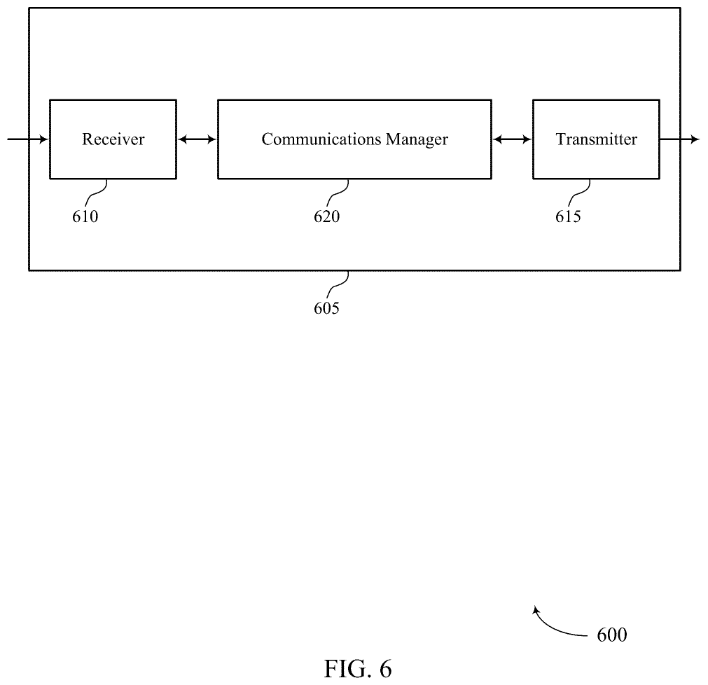

FIG. 6 shows a block diagram 600 of a device 605 that supports multi-RAT antenna management in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to multi-RAT antenna management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multi-RAT antenna management). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of multi-RAT antenna management as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for tuning a first antenna panel to a first frequency band associated with a first RAT. The communications manager 620 is capable of, configured to, or operable to support a means for tuning a second antenna panel to a second frequency band associated with a second RAT. The communications manager 620 is capable of, configured to, or operable to support a means for monitoring a traffic level of communications via the first frequency band associated with the first RAT. The communications manager 620 is capable of, configured to, or operable to support a means for selecting a third antenna panel for communications via the second frequency band based on the traffic level and an isolation level between the first antenna panel and the second antenna panel.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

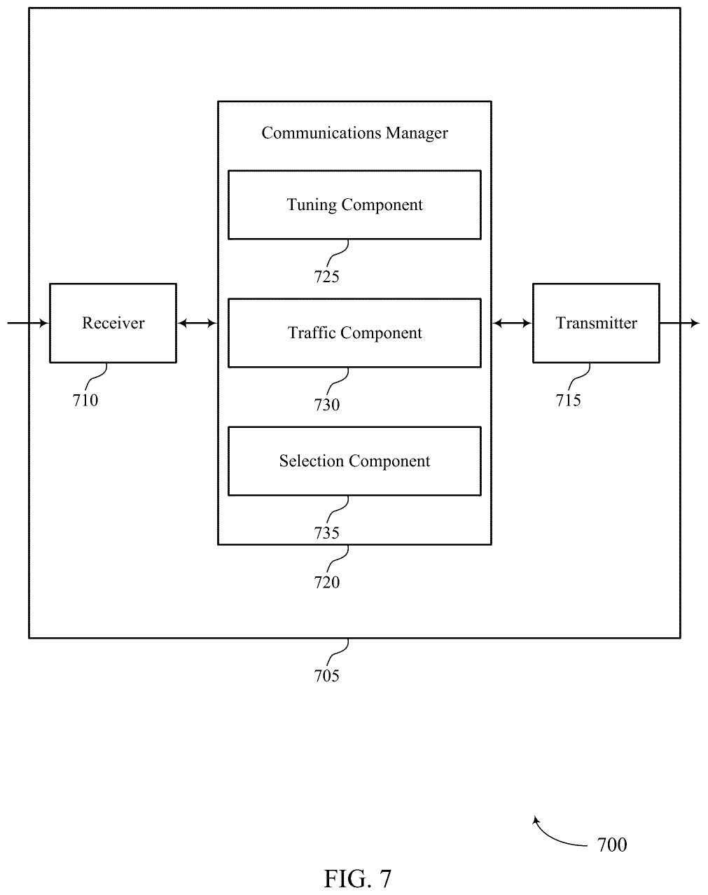

FIG. 7 shows a block diagram 700 of a device 705 that supports multi-RAT antenna management in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to multi-RAT antenna management). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multi-RAT antenna management). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of multi-RAT antenna management as described herein. For example, the communications manager 720 may include a tuning component 725, a traffic component 730, a selection component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The tuning component 725 is capable of, configured to, or operable to support a means for tuning a first antenna panel to a first frequency band associated with a first RAT. The tuning component 725 is capable of, configured to, or operable to support a means for tuning a second antenna panel to a second frequency band associated with a second RAT. The traffic component 730 is capable of, configured to, or operable to support a means for monitoring a traffic level of communications via the first frequency band associated with the first RAT. The selection component 735 is capable of, configured to, or operable to support a means for selecting a third antenna panel for communications via the second frequency band based on the traffic level and an isolation level between the first antenna panel and the second antenna panel.

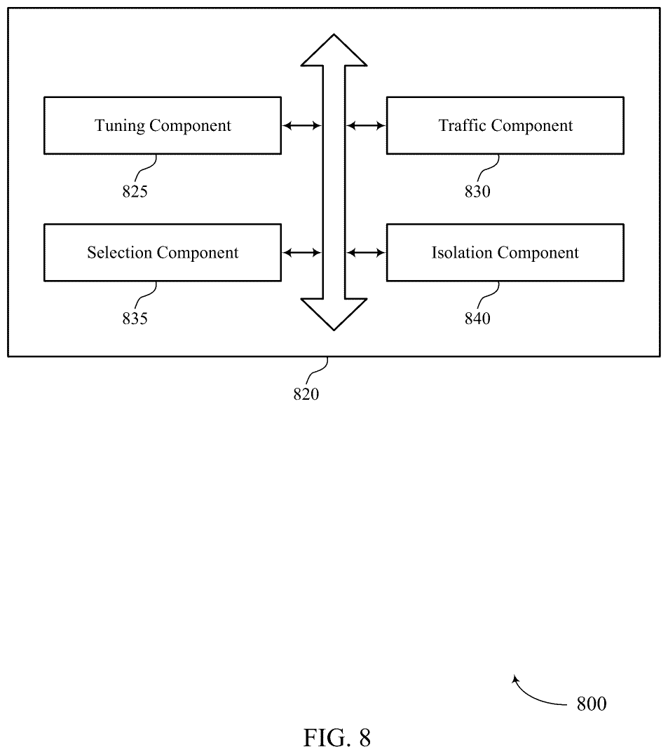

FIG. 8 shows a block diagram 800 of a communications manager 820 that supports multi-RAT antenna management in accordance with one or more aspects of the present disclosure. The communications manager 820 may be an example of aspects of a communications manager 620, a communications manager 720, or both, as described herein. The communications manager 820, or various components thereof, may be an example of means for performing various aspects of multi-RAT antenna management as described herein. For example, the communications manager 820 may include a tuning component 825, a traffic component 830, a selection component 835, an isolation component 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The tuning component 825 is capable of, configured to, or operable to support a means for tuning a first antenna panel to a first frequency band associated with a first RAT. In some examples, the tuning component 825 is capable of, configured to, or operable to support a means for tuning a second antenna panel to a second frequency band associated with a second RAT. The traffic component 830 is capable of, configured to, or operable to support a means for monitoring a traffic level of communications via the first frequency band associated with the first RAT. The selection component 835 is capable of, configured to, or operable to support a means for selecting a third antenna panel for communications via the second frequency band based on the traffic level and an isolation level between the first antenna panel and the second antenna panel.

In some examples, to support monitoring the traffic level, the traffic component 830 is capable of, configured to, or operable to support a means for monitoring the traffic level of communications via the first frequency band based on the first frequency band overlapping with, being adjacent to, being a harmonic order to, or being an intermodulation order to the second frequency band.

In some examples, to support selecting the third antenna panel, the selection component 835 is capable of, configured to, or operable to support a means for selecting the third antenna panel for communications via the second frequency band based on the traffic level satisfying a threshold traffic level.

In some examples, to support selecting the third antenna panel, the selection component 835 is capable of, configured to, or operable to support a means for selecting the third antenna panel different from the second antenna panel based on the traffic level exceeding a threshold traffic level.

In some examples, the isolation component 840 is capable of, configured to, or operable to support a means for performing isolation level measurements for antenna panels of different pairs of antenna panels, where each pair of antenna panels includes an antenna panel associated with the first RAT and an antenna panel associated with the second RAT.

In some examples, the isolation component 840 is capable of, configured to, or operable to support a means for generating a first list of antenna panels, a second list of antenna panels, or both, where the first list includes antenna panels associated with the second RAT and that correspond to antenna panel pairs that exceed a threshold isolation level, and where the second list includes antenna panels associated with the second RAT and that correspond to antenna panel pairs that are below the threshold isolation level.

In some examples, to support selecting the third antenna panel, the selection component 835 is capable of, configured to, or operable to support a means for selecting the third antenna panel from the first list. In some examples, to support selecting the third antenna panel, the selection component 835 is capable of, configured to, or operable to support a means for selecting the third antenna panel that is exclusive of the second list.

In some examples, to support selecting the third antenna panel, the selection component 835 is capable of, configured to, or operable to support a means for selecting any antenna panel from a set of antenna panels associated with the second RAT based on the traffic level being below a threshold traffic level.

In some examples, to support selecting the third antenna panel, the selection component 835 is capable of, configured to, or operable to support a means for selecting the third antenna panel based on whether a form factor state of the UE includes a first form factor state or a second form factor state, the first form factor state including an open state and the second form factor state including a closed state.

In some examples, to support monitoring the traffic level, the traffic component 830 is capable of, configured to, or operable to support a means for monitoring a quantity of packets communicated via the first frequency band associated with the first RAT within a time window.

In some examples, the first RAT is associated with a higher priority than the second RAT. In some examples, the first RAT includes one of WLAN, BT, BLE, UWB, and the second RAT includes WWAN.

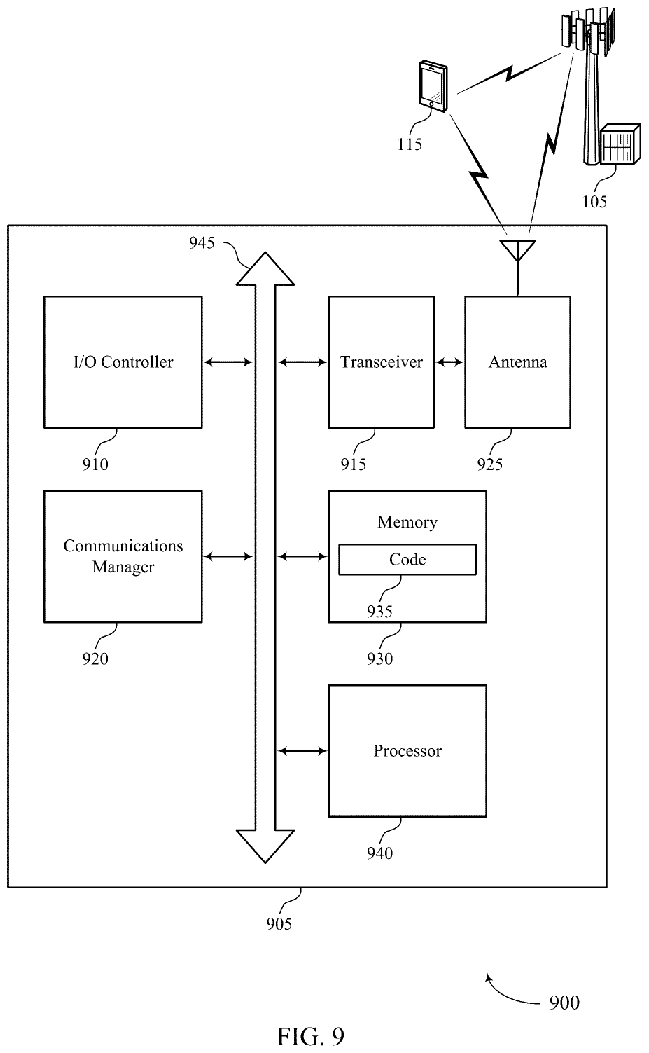

FIG. 9 shows a diagram of a system 900 including a device 905 that supports multi-RAT antenna management in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting multi-RAT antenna management). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

The communications manager 920 may support wireless communications in accordance with examples as disclosed herein. For example, the communications manager 920 is capable of, configured to, or operable to support a means for tuning a first antenna panel to a first frequency band associated with a first RAT. The communications manager 920 is capable of, configured to, or operable to support a means for tuning a second antenna panel to a second frequency band associated with a second RAT. The communications manager 920 is capable of, configured to, or operable to support a means for monitoring a traffic level of communications via the first frequency band associated with the first RAT. The communications manager 920 is capable of, configured to, or operable to support a means for selecting a third antenna panel for communications via the second frequency band based on the traffic level and an isolation level between the first antenna panel and the second antenna panel.

By including or configuring the communications manager 920 in accordance with examples as described herein, the device 905 may support techniques for more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of multi-RAT antenna management as described herein, or the at least one processor 940 and the at least one memory 930 may be otherwise configured to, individually or collectively, perform or support such operations.

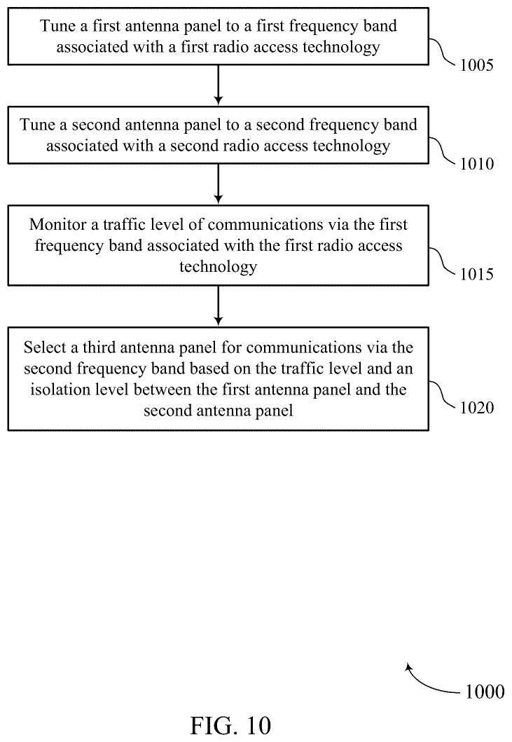

FIG. 10 shows a flowchart illustrating a method 1000 that supports multi-RAT antenna management in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include tuning a first antenna panel to a first frequency band associated with a first RAT. The operations of block 1005 may be performed in accordance with examples as disclosed herein. In some examples, aspects of the operations of 1005 may be performed by a tuning component 825 as described with reference to FIG. 8.

At 1010, the method may include tuning a second antenna panel to a second frequency band associated with a second RAT. The operations of block 1010 may be performed in accordance with examples as disclosed herein. In some examples, aspects of the operations of 1010 may be performed by a tuning component 825 as described with reference to FIG. 8.

At 1015, the method may include monitoring a traffic level of communications via the first frequency band associated with the first RAT. The operations of block 1015 may be performed in accordance with examples as disclosed herein. In some examples, aspects of the operations of 1015 may be performed by a traffic component 830 as described with reference to FIG. 8.

At 1020, the method may include selecting a third antenna panel for communications via the second frequency band based on the traffic level and an isolation level between the first antenna panel and the second antenna panel. The operations of block 1020 may be performed in accordance with examples as disclosed herein. In some examples, aspects of the operations of 1020 may be performed by a selection component 835 as described with reference to FIG. 8.

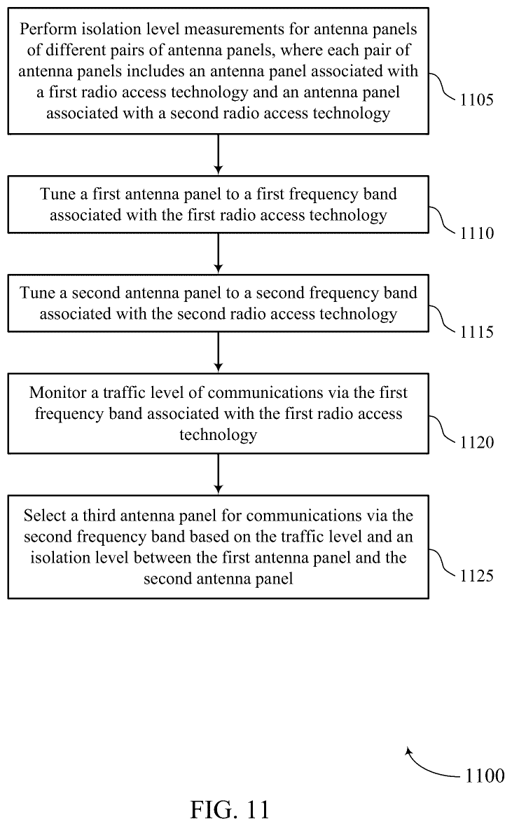

FIG. 11 shows a flowchart illustrating a method 1100 that supports multi-RAT antenna management in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include performing isolation level measurements for antenna panels of different pairs of antenna panels, where each pair of antenna panels includes an antenna panel associated with a first RAT and an antenna panel associated with a second RAT. The operations of block 1105 may be performed in accordance with examples as disclosed herein. In some examples, aspects of the operations of 1105 may be performed by an isolation component 840 as described with reference to FIG. 8.

At 1110, the method may include tuning a first antenna panel to a first frequency band associated with the first RAT. The operations of block 1110 may be performed in accordance with examples as disclosed herein. In some examples, aspects of the operations of 1110 may be performed by a tuning component 825 as described with reference to FIG. 8.

At 1115, the method may include tuning a second antenna panel to a second frequency band associated with the second RAT. The operations of block 1115 may be performed in accordance with examples as disclosed herein. In some examples, aspects of the operations of 1115 may be performed by a tuning component 825 as described with reference to FIG. 8.

At 1120, the method may include monitoring a traffic level of communications via the first frequency band associated with the first RAT. The operations of block 1120 may be performed in accordance with examples as disclosed herein. In some examples, aspects of the operations of 1120 may be performed by a traffic component 830 as described with reference to FIG. 8.

At 1125, the method may include selecting a third antenna panel for communications via the second frequency band based on the traffic level and an isolation level between the first antenna panel and the second antenna panel. The operations of block 1125 may be performed in accordance with examples as disclosed herein. In some examples, aspects of the operations of 1125 may be performed by a selection component 835 as described with reference to FIG. 8.

The following provides an overview of aspects of the present disclosure:

Aspect 1: A method for wireless communications at a UE, comprising: tuning a first antenna panel to a first frequency band associated with a first RAT; tuning a second antenna panel to a second frequency band associated with a second RAT; monitoring a traffic level of communications via the first frequency band associated with the first RAT; and selecting a third antenna panel for communications via the second frequency band based at least in part on the traffic level and an isolation level between the first antenna panel and the second antenna panel.

Aspect 2: The method of aspect 1, wherein monitoring the traffic level comprises: monitoring the traffic level of communications via the first frequency band based at least in part on the first frequency band overlapping with, being adjacent to, being a harmonic order to, or being an intermodulation order to the second frequency band.

Aspect 3: The method of any of aspects 1 through 2, wherein selecting the third antenna panel comprises: selecting the third antenna panel for communications via the second frequency band based at least in part on the traffic level satisfying a threshold traffic level.

Aspect 4: The method of any of aspects 1 through 3, wherein selecting the third antenna panel comprises: selecting the third antenna panel different from the second antenna panel based at least in part on the traffic level exceeding a threshold traffic level.

Aspect 5: The method of any of aspects 1 through 4, further comprising: performing isolation level measurements for antenna panels of different pairs of antenna panels, wherein each pair of antenna panels comprises an antenna panel associated with the first RAT and an antenna panel associated with the second RAT.

Aspect 6: The method of aspect 5, further comprising: generating a first list of antenna panels, a second list of antenna panels, or both, wherein the first list comprises antenna panels associated with the second RAT and that correspond to antenna panel pairs that exceed a threshold isolation level, and wherein the second list comprises antenna panels associated with the second RAT and that correspond to antenna panel pairs that are below the threshold isolation level.

Aspect 7: The method of aspect 6, wherein selecting the third antenna panel comprises: selecting the third antenna panel from the first list; or selecting the third antenna panel that is exclusive of the second list.

Aspect 8: The method of any of aspects 1 through 7, wherein selecting the third antenna panel comprises: selecting any antenna panel from a set of antenna panels associated with the second RAT based at least in part on the traffic level being below a threshold traffic level.

Aspect 9: The method of any of aspects 1 through 8, wherein selecting the third antenna panel comprises: selecting the third antenna panel based at least in part on whether a form factor state of the UE comprises a first form factor state or a second form factor state, the first form factor state comprising an open state and the second form factor state comprising a closed state.

Aspect 10: The method of any of aspects 1 through 9, wherein monitoring the traffic level comprises: monitoring a quantity of packets communicated via the first frequency band associated with the first RAT within a time window.

Aspect 11: The method of any of aspects 1 through 10, wherein the first RAT is associated with a higher priority than the second RAT.

Aspect 12: The method of any of aspects 1 through 11, wherein the first RAT comprises one of WLAN, BT, BLE, UWB, and the second RAT comprises WWAN.

Aspect 13: A UE for wireless communications, comprising one or more memories storing processor-executable code, and one or more processors coupled with the one or more memories and individually or collectively operable to execute the code to cause the UE to perform a method of any of aspects 1 through 12.

Aspect 14: A UE for wireless communications, comprising at least one means for performing a method of any of aspects 1 through 12.

Aspect 15: A non-transitory computer-readable medium storing code for wireless communications, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
tune a first antenna panel to a first frequency band associated with a first radio access technology;
tune a second antenna panel to a second frequency band associated with a second radio access technology;
monitor a traffic level of communications via the first frequency band associated with the first radio access technology; and
select a third antenna panel for communications via the second frequency band based at least in part on the traffic level and an isolation level between the first antenna panel and the second antenna panel.

2. The UE of claim 1, wherein, to monitor the traffic level, the one or more processors are individually or collectively operable to execute the code to cause the UE to:
monitor the traffic level of communications via the first frequency band based at least in part on the first frequency band overlapping with, being adjacent to, being a harmonic order to, or being an intermodulation order to the second frequency band.

3. The UE of claim 1, wherein, to select the third antenna panel, the one or more processors are individually or collectively operable to execute the code to cause the UE to:
select the third antenna panel for communications via the second frequency band based at least in part on the traffic level satisfying a threshold traffic level.

4. The UE of claim 1, wherein, to select the third antenna panel, the one or more processors are individually or collectively operable to execute the code to cause the UE to:
select the third antenna panel different from the second antenna panel based at least in part on the traffic level exceeding a threshold traffic level.

5. The UE of claim 1, wherein the one or more processors are individually or collectively further operable to execute the code to cause the UE to:
perform isolation level measurements for antenna panels of different pairs of antenna panels, wherein each pair of antenna panels comprises an antenna panel associated with the first radio access technology and an antenna panel associated with the second radio access technology.

6. The UE of claim 5, wherein the one or more processors are individually or collectively further operable to execute the code to cause the UE to:
generate a first list of antenna panels, a second list of antenna panels, or both, wherein the first list comprises antenna panels associated with the second radio access technology and that correspond to antenna panel pairs that exceed a threshold isolation level, and wherein the second list comprises antenna panels associated with the second radio access technology and that correspond to antenna panel pairs that are below the threshold isolation level.

7. The UE of claim 6, wherein, to select the third antenna panel, the one or more processors are individually or collectively operable to execute the code to cause the UE to:
select the third antenna panel from the first list; or
select the third antenna panel that is exclusive of the second list.

8. The UE of claim 1, wherein, to select the third antenna panel, the one or more processors are individually or collectively operable to execute the code to cause the UE to:
select any antenna panel from a set of antenna panels associated with the second radio access technology based at least in part on the traffic level being below a threshold traffic level.

9. The UE of claim 1, wherein, to select the third antenna panel, the one or more processors are individually or collectively operable to execute the code to cause the UE to:
select the third antenna panel based at least in part on whether a form factor state of the UE comprises a first form factor state or a second form factor state, the first form factor state comprising an open state and the second form factor state comprising a closed state.

10. The UE of claim 1, wherein, to monitor the traffic level, the one or more processors are individually or collectively operable to execute the code to cause the UE to:
monitor a quantity of packets communicated via the first frequency band associated with the first radio access technology within a time window.

11. The UE of claim 1, wherein the first radio access technology is associated with a higher priority than the second radio access technology.

12. The UE of claim 1, wherein the first radio access technology comprises one of wireless local area network, Bluetooth, Bluetooth Low Energy, Ultra-wideband, and the second radio access technology comprises wireless wide area network.

13. A method for wireless communications at a user equipment (UE), comprising:
tuning a first antenna panel to a first frequency band associated with a first radio access technology;
tuning a second antenna panel to a second frequency band associated with a second radio access technology;
monitoring a traffic level of communications via the first frequency band associated with the first radio access technology; and
selecting a third antenna panel for communications via the second frequency band based at least in part on the traffic level and an isolation level between the first antenna panel and the second antenna panel.

14. The method of claim 13, wherein monitoring the traffic level comprises:
monitoring the traffic level of communications via the first frequency band based at least in part on the first frequency band overlapping with, being adjacent to, being a harmonic order to, or being an intermodulation order to the second frequency band.

15. The method of claim 13, wherein selecting the third antenna panel comprises:
selecting the third antenna panel for communications via the second frequency band based at least in part on the traffic level satisfying a threshold traffic level.

16. The method of claim 13, wherein selecting the third antenna panel comprises:
selecting the third antenna panel different from the second antenna panel based at least in part on the traffic level exceeding a threshold traffic level.

17. The method of claim 13, further comprising:
performing isolation level measurements for antenna panels of different pairs of antenna panels, wherein each pair of antenna panels comprises an antenna panel associated with the first radio access technology and an antenna panel associated with the second radio access technology.

18. The method of claim 13, wherein selecting the third antenna panel comprises:
selecting any antenna panel from a set of antenna panels associated with the second radio access technology based at least in part on the traffic level being below a threshold traffic level.

19. A user equipment (UE) for wireless communications, comprising:
means for tuning a first antenna panel to a first frequency band associated with a first radio access technology;
means for tuning a second antenna panel to a second frequency band associated with a second radio access technology;
means for monitoring a traffic level of communications via the first frequency band associated with the first radio access technology; and
means for selecting a third antenna panel for communications via the second frequency band based at least in part on the traffic level and an isolation level between the first antenna panel and the second antenna panel.

20. The UE of claim 19, wherein the means for monitoring the traffic level comprise:
means for monitoring the traffic level of communications via the first frequency band based at least in part on the first frequency band overlapping with, being adjacent to, being a harmonic order to, or being an intermodulation order to the second frequency band.
